(19) United States
(12) Patent Application Publication
(10) Pub. No.: US 2016/0312745 A1
(43) Pub. Date: Oct. 27, 2016

(54) Piston Engine and Associated Operating Method

(71) Applicant: DAIMLER AG, Stuttgart (DE)

(72) Inventors: Frank Michael BENZ, Ostfildern (DE); Thomas HAARMANN, Berlin (DE); Kai HOFFMANN, Stuttgart (DE); Kai KANNING, Stuttgart (DE); Thomas KOCH, Pfinztal-Berghausen (DE); Johannes RITZINGER, Stuttgart (DE); Tobias SCHOEFFLER, Stuttgart (DE)

(73) Assignee: Daimler AG, Stuttgart (DE)

(21) Appl. No.: 15/102,744

(22) PCT Filed: Nov. 29, 2014
(86) PCT No.: PCT/EP2014/003198

§ 371 Date: Jun. 8, 2016

(30) Foreign Application Priority Data
Dec. 11, 2013 (DE) 10 2013 020 923.4

(51) Int. Cl. F02M 26/17; F01L 1/20; F01L 1/34

(52) U.S. Cl. CPC F02M 26/17; F01L 1/34; F01L 1/20

(57) ABSTRACT

A method for operating an internal combustion piston engine, preferably a spark ignition engine, is disclosed. For each combustion chamber at least one intake valve is closed prematurely or belatedly and an exhaust gas recirculation can be carried out. For each combustion chamber at least two intake valves are provided which are opened at least during the exhaust gas recirculation with different maximum strokes.

### BACKGROUND AND SUMMARY OF THE INVENTION

The present invention relates to a method for operating an internal combustion piston engine, preferably a spark ignition engine, wherein for each combustion chamber an intake valve is closed prematurely or belatedly and wherein an exhaust gas recirculation can be carried out. The invention also relates to an internal combustion piston engine, in particular a spark ignition engine, which is suitable for carrying out such a method for operation. Finally, the present invention relates to the use of a valve train for controlling intake valves in a piston engine according to such a method of operation.

By a premature closure of the intake valve, that is to say by a closure of the intake valve before a bottom dead center of the associated piston, a so-called Miller cycle (also known earlier as a Miller process) can be carried out, wherein a reduced filling of the respective combustion chamber takes place, in order ultimately to be able to enlarge the geometric expansion in the subsequent expansion stroke. As a result, the fuel can be consumed more efficiently, since more expansion energy can be used in the respective expansion process, in the event of a belated closure of the intake valve the same situation is produced, since in this case the intake valve closes after the bottom dead center of the respective piston, so that the (thermodynamic) compression stroke is decreased. This operation is known as an Atkinson cycle (also later a Miller process).

In this case, for the Miller cycle and the Atkinson cycle, piston engines are relevant which operate according to the four-stroke principle, wherein in a first stroke in the respective cylinder the respective piston carries out an expansion stroke with the combustion process, in a second stroke it carries out an exhaust stroke for discharging the exhaust gas from combustion, in a third stroke it carries out an intake stroke for filling with fresh gas and in a fourth stroke it carries out a compression stroke for compressing the fresh gas used on a crankshaft of the piston engine, which is driven by the respective piston, the individual cycles or strokes of the piston can be associated with the following crankshaft angle ranges. The expansion stroke lasts from crankshaft angles (KWW) of 0° to 180°, the exhaust stroke lasts from crankshaft angles of 180° to 360°, the intake stroke lasts from crankshaft angles of 360° to 540° and the compression stroke lasts from crankshaft angles of 540° to 720°, wherein a crankshaft angle of 720° of one four-stroke cycle corresponds to a crankshaft angle of 0° of the next four-stroke cycle. The top dead center positions of the piston movement are located at crankshaft angles of 0°, 360° and 720°. On the other hand, the bottom dead centers of the respective piston are located at crankshaft angles of 0°, 180° and 540°. The intake valve usually closes at a crankshaft angle of approximately 540°, that is to say at the bottom dead center between the intake stroke and the compression stroke. In the event of early intake closure, that is to say in the Miller cycle, the intake valve closes before a crankshaft angle of 540°, whereas in the event of late intake closure, that is to say in the Atkinson cycle, it closes after a crankshaft angle of 540°. In order that the Miller cycle or the Atkinson cycle have a perceptible effect on the efficiency of the piston engine, the closure of the intake valve takes place substantially before or after the respective bottom dead center, specifically preferably in a range of crankshaft angles from 80° to 60° inclusive and in particular at approximately 70° before or after the bottom dead center at 540°.

An exhaust gas recirculation takes place primarily with the object of reducing the NOx pollutant emissions of the piston engine. In order to be able to facilitate high exhaust gas recirculation rates, in the respective combustion chamber the greatest possible turbulence is necessary. However, in connection with the Miller cycle or the Atkinson cycle, a high degree of turbulence in the combustion chamber cannot be achieved or can only be achieved with great difficulty, so that in the conventional method for operation the required high exhaust gas recirculation rates cannot be set or are associated with an increased risk of knocking and an increased risk of misfires.

A method for operating a spark ignition engine of the type referred to above is known from EP 2 041 414 B1.

The present invention deals with the problem of specifying an improved embodiment of a method of operation of the type mentioned in the introduction or for an associated piston engine or for an associated valve drive which is characterized in particular in that higher exhaust gas recirculation rates can be set.

The invention is based on the general idea of associating at least two intake valves with the respective combustion chamber, so that the filling of the respective combustion chamber takes place by means of the at least two intake valves which are controlled during exhaust gas recirculation system for a method of operation with premature or belated closure of the intake valves so that the two intake valves have different maximum strokes. In this case the invention utilizes the knowledge that the maximum stroke during opening of the respective intake valve significantly influences the inflow of the gas mixture. In this case it has been shown that the production of two different intake flows, which are generated by different maximum strokes of the intake valves, leads to an increased turbulence in the combustion chamber. The increased turbulence improves the compatibility of the subsequent combustion process for recirculated exhaust gas, so that higher exhaust gas recirculation rates can be set without the risk of knocking and the risk of misfires, Thus the emission of pollutants from the piston engine can be reduced by the proposal according to the invention.

According to an advantageous embodiment, the maximum stroke of one intake valve in a range from 40% to 70% inclusive, preferably in a range from 50% to 65% inclusive, in particular approximately 55%, of the maximum stroke of the other intake valve. It has been shown that with these relationships between the two maximum strokes particularly high turbulences can be generated in the respective combustion chamber.

In another embodiment at least one of the two intake valves may have, relative to the crankshaft angle, a stroke curve which has an angle range with a constant opening stroke. This means that the respective stroke curve in the angle range has a fiat plateau, wherein the opening stroke of the intake valve does not change. Consequently, during this angle range a constant intake flow can be set, which improves the formation of specific turbulences. For example, the angle range in which the opening stroke of the respective intake valve is constant can preferably be in a range of crankshaft angles from 30° to 50° inclusive, preferably in a range of crankshaft angles from 40° to 45° inclusive.

According to an advantageous modification, the constant opening stroke can form the maximum stroke of the respective intake valve. This means that the respective intake valve, with the respective angle range with its maximum stroke constant, is opened. This measure also results in the required turbulence being generated in a targeted manner.

In another modification it may be provided that only one of the two intake valves has such an angle range with a constant opening stroke. This preferably relates to the intake valve which has the smaller maximum stroke. As an alternative it may be provided that both intake valves in each case have such an angle range with a constant opening stroke.

An embodiment in which the two intake valves open and close synchronously is particularly advantageous. Accordingly both intake valves have the same opening time window. In particular the opening strokes of the two intake valves extend substantially congruently in an opening range and in a closing range. As a result, unambiguously defined times for the start of intake and the end of intake are made possible. If both stroke carves have an angle range with constant opening stroke, in particular with constant maximum stroke, the angle range of the intake valve with smaller maximum stroke is substantially greater than, in particular approximately two times greater than the angle range of the intake valve with a greater maximum stroke. For example, this greater angle range can then be in a range of crankshaft angles from 80° to 120° inclusive, preferably in a range of crankshaft angles from 90° to 110° inclusive.

In another embodiment it may be provided that the two intake valves control two separate intake channels which in each case guide the respective gas mixture to the combustion chamber. As a result, interactions in the gas stream upstream of the intake valve can be largely avoided, in order to improve the efficiency of the turbulence in the combustion chamber.

According to a modification it may be provided that only one of the two intake channels is configured as a vortex channel. This is preferably the intake channel which is associated with the intake valve with the greater maximum stroke. Whilst a conventional delivery channel delivers the gas mixture to the combustion chamber largely radially and axially with respect to a longitudinal central axis of the associated cylindrical combustion chamber, a vortex channel is disposed or oriented so that the gas flow delivered to the combustion chamber also has a tangential component, that is to say a component in the circumferential direction. Thus by means of the vortex channel a vortex flow which is advantageous for the turbulence can be generated in the combustion chamber.

An internal combustion piston engine according to the invention, which is preferably a spark ignition engine, is equipped with an exhaust gas recirculation system, which is preferably an external exhaust gas recirculation system. Furthermore, the piston engine is equipped with at least two intake valves per combustion chamber and with a valve train for controlling the intake valve. Moreover, the valve train is configured so that it can control the intake valves according to the method of operation described above. In other words, the valve train can control the two intake valves for a Miller operation or an Atkinson operation for carrying out different maximum strokes.

In the use according to the invention a valve train, which is provided for controlling at least two intake valves of a combustion chamber of an internal combustion piston engine, in particular a spark ignition engine, is used specifically so that it carries out the method of operation described above. For this purpose the valve train is configured in a suitable manner.

A valve train which can control at least two intake valves with different maximum strokes has, for example, two separate cams in order to be able to control the two separate intake valves individually. The two cams then have geometrically different cam contours, in order to generate the two different stroke curves for the two separate intake valves. Likewise, it is conceivable to provide a common cam for the two intake valves which, however, have two different cam contours. Moreover, in order to be able to switch between a normal operation and a Miller operation or Atkinson operation, the valve train can be equipped with a camshaft adjustment. Furthermore, for the normal operation and/or for a conventional Miller operation or Atkinson operation it is conceivable in principle to configure the valve train so that the two intake valves can also be controlled completely synchronously, that is to say in particular also with the same maximum strokes. This can be achieved, for example, by means of adjustable camshafts and/or adjustable tilting levers and the like.

Further important features and advantages of the invention are disclosed by the subordinate claims, from the drawings and from the associated description with reference to the drawings.

It will he understood that the features referred to above and still to be explained below can be used not only in the respective combination stated but also in other combinations or by themselves without departing from the scope of the present invention.

Preferred exemplary embodiments of the invention are illustrated in the drawings and are explained in greater detail in the following description, Wherein the same reference signs refer to components Which are the same or similar or functionally the same.

### BRIEF DESCRIPTION OF THE DRAWINGS

FIGS. 1 and 2 each show a diagram with stroke curves of two intake valves, during an intake stroke in two different embodiments.

### DETAILED DESCRIPTION OF THE DRAWINGS

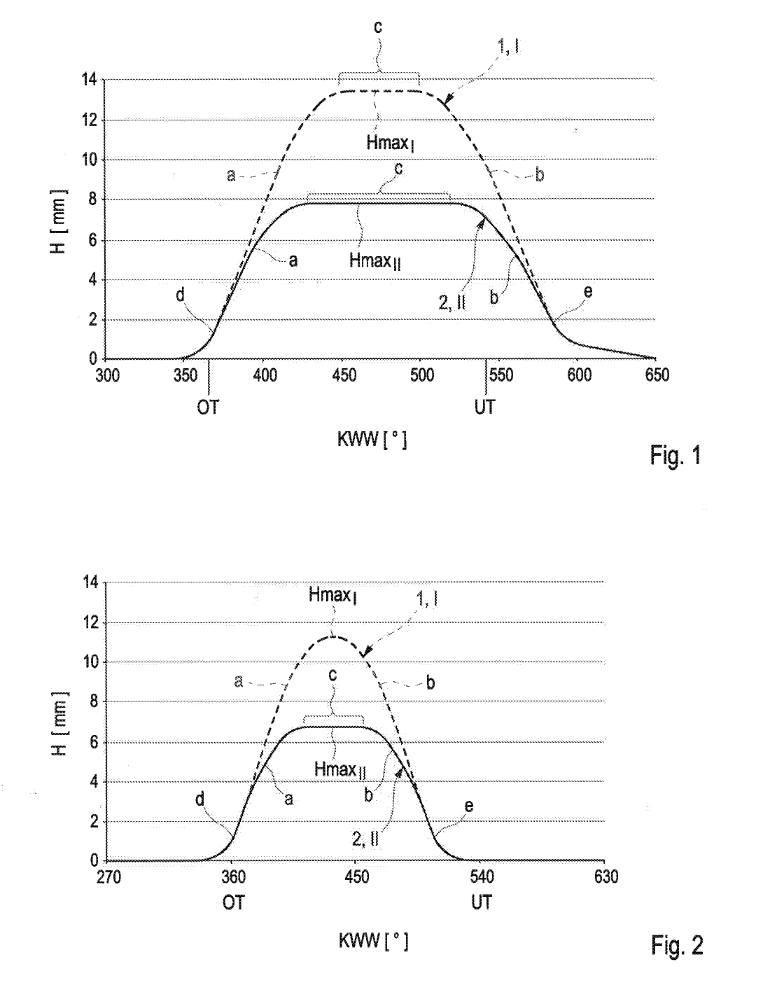

The diagrams of FIGS. 1 and 2 each show a valve lift H in mm on the ordinate and a crankshaft angle KWW in degrees on the abscissa. In this ease, for example, valve lifts H from 0 to 14 mm are shown in FIGS. 1 and 2, In FIG. 1 a crankshaft angle range from 300° to 650° is shown by way of example. In FIG. 2 a crankshaft angle range from 270° to 630° is shown by way of example.

In both diagrams, two valve lift curves I, II of two intake valves 1, 2 are shown, which are associated with the same combustion chamber of an internal combustion piston engine. The piston engine is preferably a spark ignition engine. The piston engine operates according to the four-stroke principle. The angle ranges shown here cover an intake stroke of a piston associated with the respective combustion chamber. The intake stroke extends over crankshaft angles of 360° to 540°, that is to say from a top dead center OT at 360° to a bottom dead center UT at 540°.

In both diagrams of FIGS. 1 and 2 a first stroke curve I of a first intake valve 1 is represented by a broken line and a second stroke curve II of a second intake valve 2 is represented by a solid line. The method of operation presented here presupposes that at least two intake valves 1, 2 per combustion chamber are provided, which are represented in FIGS. 1 and 2 by the two stroke curves I and II. In this case, a valve train for controlling the intake valves 1, 2 is configured so that with respect to the bottom dead center at a crankshaft angle of 540° a premature or belated closure of the intake valves 1, 2 is possible. FIG. 1 shows an Atkinson operation with belated intake closure, wherein the intake valves 1 and 2 close at crankshaft angles of approximately 600° to 650°, in contrast to this, FIG. 2 shows the stroke curves I and II for a Miller operation with premature intake closure. In this case the two intake valves 1, 2 close at a crankshaft angle of approximately 510°. In both cases the intake valves 1, 2 open approximately at the top dead center OT at a crankshaft angle of 360°. It is notable that the two intake valves 1, 2 with different maximum strokes Hmax_{I} or Hmax_{II} are opened. In the examples the first intake valve 1 in each case has the greater maximum stroke Hmax. In this case the smaller maximum stroke Hmax_{II} is approximately between 40% and 70% of the greater maximum stroke Hmax_{I}. In the examples shown here the smaller maximum stroke Hmax_{II} is approximately 60% of the greater maximum stroke Hmax_{I}. Purely by way of example, in FIG. 1 the greater maximum stroke Hmax_{I} is approximately 13 mm, whilst the smaller maximum stroke Hmax_{II} is approximately 8 mm. For example, in FIG. 2 the greater maximum stroke Hmax_{I} is approximately 11 mm, whilst the smaller maximum stroke Hmax_{II} is approximately 7 mm.

The Miller cycle according to FIG. 2 or the Atkinson cycle according to FIG. 1 are employed especially when high exhaust gas recirculation rates are achieved for the respective combustion chamber. Moreover, this means that the respective piston engine is equipped with an exhaust gas recirculation system. In this connection an external exhaust gas recirculation system is preferably used, in which the exhaust gas is diverted outside the respective combustion chamber and is delivered to the fresh gas supply outside the respective combustion chamber, so that ultimately a mixture of fresh air, combustion gas and recirculated exhaust gas is delivered to the combustion chamber.

According to the embodiments illustrated here it may he provided that at least in one of the two intake valves 1, 2 with respect to the crankshaft angle a stroke curve I, II is provided which has an angle range c in which the opening stroke H remains constant, In each case the respective stroke curve I, II has an angle range a in which the opening stroke H increases and an angle range b in which the opening stroke II decreases, which ranges in this case merge into one another with a constant opening stroke H over the angle range c. The maximum stroke Hmax of the respective intake valve 1, 2 is advantageously constant in the angle range c.

In the embodiment shown in FIG. 1 both stroke curves I, II of the two intake valves 1, 2 in each case have precisely such an angle range c with a constant opening stroke H, which in each case is formed by the respective maximum stroke Hmax. In contrast to this, FIG. 2 shows an embodiment in which only one of the two intake valves 1, 2 has a stroke curve I, II which shows precisely such an angle range c with a constant opening stroke H, which is likewise formed there by the maximum stroke Hmax. In this case, according to the preferred embodiment shown in FIG. 2, this relates to the stroke curve II of the second intake valve 2, which has the smaller maximum stroke Hmax_{II}. The first intake valve 1, which has the greater maximum stroke Hmax_{I}, does not exhibit such an angle range c with a constant opening stroke H. On the contrary, in the stroke curve I of the first intake valve 1 the angle range a with an increasing opening stroke H and the angle range b with a decreasing opening stroke H merge directly into one another.

In the preferred embodiments illustrated here, the two intake valves 1, 2 open and close synchronously, so that the two separate stroke curves I, II extend congruently in an opening range d as well as in a closing range e.

In the embodiment illustrated in FIG. 1, in the first stroke curve I the angle range c with a constant maximum stroke Hmax_{I} forms a plateau which extends over a crankshaft angle of approximately 50°. On the other hand, in the second stroke curve II the angle range c with a constant maximum stroke Hmax_{II} forms a plateau which extends over a crankshaft angle of approximately 100°. In FIG. 2 a plateau Which extends over a crankshaft angle of approximately 40° is formed by the angle range c at a constant stroke curve II of the second intake valve 2.

In the embodiments illustrated here the two stroke curves I, II of the two intake valves 1, 2 are also configured largely symmetrically, so that the angle ranges a with an increasing opening stroke H are largely in mirror symmetry with the angle range b with a decreasing opening stroke H.

Separate intake channels can he associated with the two intake valves 1, 2 so that the two intake valves 1, 2 control two separate intake channels. In principle these may be two separate inflow channels. However, it is preferably provided that at least one of the intake channels is configured as a vortex channel. Unlike a conventional inflow channel, such a vortex channel has an orientation which, in the gas flow which can flow through this vortex channel into the combustion chamber, has a flow component in the circumferential direction of the cylindrical combustion chamber. In contrast to this, the gas flow generated by an inflow channel is oriented virtually exclusively radially and/or axially with respect to the longitudinal central axis of the respective cylinder.

1.-10. (canceled)

11. A method for operating an internal combustion piston engine, comprising the steps of:
closing prematurely or belatedly two intake valves of a combustion chamber with respect to a bottom dead center of a crankshaft;
carrying out an exhaust gas recirculation;
opening the two intake valves at least during the exhaust gas recirculation with different maximum strokes; and
opening and closing the two intake valves synchronously.

12. The method according to claim 11, wherein at least one of the two intake valves has, with respect to a crankshaft angle, a stroke curve which has an angle range with a constant opening stroke.

13. The method according to claim 12, wherein the constant opening stroke forms the respective maximum strokes of the two intake valves.

14. The method according to claim 12, wherein only one of the two intake valves has the angle range with the constant opening stroke.

15. The method according to claim 12, wherein both of the two intake valves have the angle range with the constant opening stroke.

16. The method according to claim 11, wherein the two intake valves control two separate intake channels.

17. The method according to claim 16, wherein only one of the two intake channels is configured as a vortex channel.

18. The method according to claim 11, wherein the internal combustion engine is a spark ignition engine.

19. An internal combustion piston engine, comprising:
a combustion chamber with two intake valves; and
a valve train for controlling the two intake valves, wherein the valve train controls the two intake valves according to the method of claim 11.

20. The internal combustion piston engine according to claim 19, wherein the internal combustion piston engine is a spark ignition engine.

21. A method for using a valve train for controlling two intake valves of a combustion chamber of an internal combustion piston engine comprising using the valve train according to the method of claim 11.

22. The method according to claim 21, wherein the internal combustion piston engine is a spark ignition engine.
